(19) United States
(12) Patent Application Publication
(10) Pub. No.: US 2026/0064092 A1
(43) Pub. Date: Mar. 5, 2026

(54) PREDICTIVE HYDROGEN GRID OPTIMIZATION

(71) Applicant: ZeroAvia, Inc., Hollister, CA (US)

(72) Inventors: Ro Kirchev, Hollister, CA (US); Parker Bryant, Hollister, CA (US); Arnab Chatterjee, Cirencester (GB); Ewan Harry-Thomas, Cirencester (GB); Aleksei Bolisov, Hollister, CA (US); Oleksii Kononenko, Hollister, CA (US); Alexey Vorobyev, Hollister, CA (US); Yury Maximov, Hollister, CA (US); Aleksei Ivanov, Cirencester (GB)

(21) Appl. No.: 18/818,249

(22) Filed: Aug. 28, 2024

(51) Int. Cl. G05B 13/04

(52) U.S. Cl. CPC G05B 13/048; G05B 13/042

(57) ABSTRACT

Methods and systems for optimizing hydrogen fuel production facilities include processing user input data and sensor data from hardware sensors of a hydrogen fuel production facility with a computerized device to model at least one microgrid hydrogen-generating plant. A three-stage convex optimization model is operated on the computerized device to determine at least one implementation parameter of the microgrid hydrogen-generating plant. At least one hardware component of the microgrid hydrogen-generating plant is modeled. The hardware components include at least an electrolyzer. A model predictive control (MPC) controller is used to determine an optimal power flow schedule for a selected control scenario and schedule module, thereby optimizing the generated sensor data and the user input data over a time series window.

### FIELD OF THE DISCLOSURE

The present disclosure relates to hydrogen fuel production systems. The disclosure has particular utility with predictive optimization of hydrogen grid fuel systems having hydrogen-generating plants used for providing hydrogen fuel for aviation and other uses and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

Hydrogen (H2) fuel cells may be used as power sources for hydrogen-powered motors of electric vehicles and hybrid electric vehicles, including aircraft. Hydrogen fuel cell aircraft utilize hydrogen storage tanks to store hydrogen needed for powering fuel cells of the vehicle, where hydrogen is transferred to the hydrogen fuel cells during operation to thereby power the propulsion system of the aircraft. Hydrogen fuel for flight applications is conventionally stored in subterranean tanks in locations which are readily accessible to aircraft or transport refueling vehicles for aircraft, such as mobile storage and dispensing units.

Hydrogen has shown numerous benefits in providing a clean energy fuel source for aviation and in other industries, but the production of hydrogen is still relatively expensive and subject to various environmental conditions, which are inherently variable and unpredictable. This variability poses significant operational challenges, including energy inefficiency, safety risks, and financial uncertainties to manufactures and users of hydrogen fuel.

Current methods of generating and distributing hydrogen for use as a fuel, both in liquid and gaseous forms, are not optimized. For instance, these current methods do not account for optimization with regards to a location of a hydrogen fuel plant, the project lifetime, the use of certain hardware devices in the fuel plant, and various financial considerations, such as for both capital and operational expenditures. Additionally, current hydrogen fuel production is not optimized for the specific aviation use case, where fuel demand is constrained by the specific ecosystem of aircraft, by the type of airplanes, and by the ground infrastructure in an airport, e.g., hydrogen storage tanks, and other factors.

To provide improvements in the optimization of hydrogen fuel production systems, it is possible to use a multi-stage integrated tool that allows for the design, deployment, and management of efficient microgrid hydrogen-generating plants, and/or clusters of plants, for aviation. In one example, such a system may include a three-stage convex optimization to determine a plant or plant cluster location, plant design, and a plant management solution that minimizes the cost of hydrogen production where cost may be defined by the operator, such as, for this instance, the levelized cost of hydrogen production (LCOH). Convex optimization may be used where continuous setpoint of the hydrogen facility microgrid power flow controller is derived by modelling electrolyzer operation and related equipment. Such a system may be updated in real-time or configured to run over other operator-defined time scales.

The present disclosure can also be viewed as providing methods for optimizing a hydrogen fuel production facility. In this regard, one embodiment of such a method, among others, can be broadly summarized by the following steps: generating sensor data from at least one hardware sensor of a hydrogen fuel production facility; receiving, in a computerized device, the generated sensor data and user input data, wherein the generated sensor data and the user input data are stored on a non-transitory memory of the computerized device; processing, with at least one processor of the computerized device, at least a portion of the generated sensor data and the user input data to model at least one microgrid hydrogen-generating plant by: using a three-stage convex optimization model operated on the computerized device to determine at least one implementation parameter of the microgrid hydrogen-generating plant; modeling at least one hardware component of the microgrid hydrogen-generating plant, wherein the hardware components include at least an electrolyzer; and using a model predictive control (MPC) controller to determine an optimal power flow schedule for a selected control scenario and schedule module, thereby optimizing the generated sensor data and the user input data over a time series window.

In one aspect, the time series window further comprises at least one of: real-time or an operator-defined time scale.

In another aspect, modeling the hardware component of the microgrid hydrogen-generating plant further comprises simulating the hardware component to predict performance of the microgrid hydrogen-generating plant.

In this aspect, the hardware component of the microgrid hydrogen-generating plant further comprises a flow meter, wherein modeling the at least one hardware component further comprises using a sampling module to sample hydrogen demand based at least on a reading from the flow meter.

In yet another aspect, the at least one implementation parameter of the microgrid hydrogen-generating plant further comprises at least one of aviation hydrogen fuel demand, hydrogen-fuel-powered aircraft parameters, airport parameters, or hydrogen fuel storage infrastructure parameters.

In another aspect, modeling the at least one hardware component of the microgrid hydrogen-generating plant further comprises modeling at least one of an electric energy generation subsystem, a battery energy storage system, or a hydrogen fuel cell.

In yet another aspect, using the MPC controller further comprises analyzing a techno-economic condition and a plant energy management system with at least one artificial intelligence (AI) data model.

In this aspect, analyzing the plant energy management system further comprises analysis of actions, environmental parameters, feedback parameters, and internal states of the microgrid hydrogen-generating plant.

In another aspect, modeling the microgrid hydrogen-generating plant further comprises detecting anomalies using an observation database.

In yet another aspect, modeling the hardware component of the microgrid hydrogen-generating plant further comprises generating a constant approximation of electrolyzer efficiency as a function of power.

Embodiments of the present disclosure also provide a system for optimizing a hydrogen fuel production facility. Briefly described, in architecture, one embodiment of the system, among others, can be implemented as follows. At least one hardware sensor of a hydrogen fuel production facility generates sensor data. A computerized device receives the generated sensor data and user input data, wherein the generated sensor data and the user input data are stored on a non-transitory memory of the computerized device. At least one processor of the computerized device processes at least a portion of the generated sensor data and the user input data to model at least one microgrid hydrogen-generating plant by: using a three-stage convex optimization model operated on the computerized device to determine at least one implementation parameter of the microgrid hydrogen-generating plant; modeling at least one hardware component of the microgrid hydrogen-generating plant, wherein the hardware components include at least an electrolyzer; and using a MPC controller to determine an optimal power flow schedule for a selected control scenario and schedule module, thereby optimizing the generated sensor data and the user input data over a time series window.

In one aspect, the time series window further comprises at least one of: real-time or an operator-defined time scale.

In another aspect, modeling the hardware component of the microgrid hydrogen-generating plant further comprises simulating the hardware component to predict performance of the microgrid hydrogen-generating plant.

In this aspect, the hardware component of the microgrid hydrogen-generating plant further comprises a flow meter, wherein modeling the at least one hardware component further comprises using a sampling module to sample hydrogen demand based at least on a reading from the flow meter.

In yet another aspect, the at least one implementation parameter of the microgrid hydrogen-generating plant further comprises at least one of aviation hydrogen fuel demand, hydrogen-fuel-powered aircraft parameters, airport parameters, or hydrogen fuel storage infrastructure parameters.

In another aspect, modeling the at least one hardware component of the microgrid hydrogen-generating plant further comprises modeling at least one of an electric energy generation subsystem, a battery energy storage system, or a hydrogen fuel cell.

In yet another aspect, using the MPC controller further comprises analyzing a techno-economic condition and a plant energy management system with at least one AI data model.

In this aspect, analyzing the plant energy management system further comprises analysis of actions, environmental parameters, feedback parameters, and internal states of the microgrid hydrogen-generating plant.

In another aspect, modeling the microgrid hydrogen-generating plant further comprises detecting anomalies using an observation database.

In yet another aspect, modeling the hardware component of the microgrid hydrogen-generating plant further comprises generating a constant approximation of electrolyzer efficiency as a function of power.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIG. 1 is a diagrammatic illustration of a system for optimizing a hydrogen fuel production facility, in accordance with the present disclosure;

FIG. 2 is a techno-economic workflow diagram of the system of FIG. 1, in accordance with the present disclosure;

FIG. 3 is a diagrammatic illustration of a time series table generator module of the system of FIG. 1, in accordance with the present disclosure;

FIG. 4 is a workflow diagram of an information flow process module to generate the table of hydrogen orders of the system of FIG. 1, in accordance with the present disclosure;

FIG. 5 is a diagrammatic illustration of an observation database generation module of the system of FIG. 1, in accordance with the present disclosure;

FIG. 6 is a diagrammatic illustration of a dynamical demand correction module of the system of FIG. 1, in accordance with the present disclosure;

FIG. 7 is a workflow diagram of a control scenario selection module used with the system of FIG. 1, in accordance with the present disclosure;

FIG. 8 is a workflow diagram of a scheduling module used with the system of FIG. 1, in accordance with the present disclosure;

FIG. 9 is a diagrammatic illustration of cluster topologies used with the system of FIG. 1, in accordance with the present disclosure; and

FIG. 10 is a flowchart illustrating a method for optimizing a hydrogen fuel production facility, in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

To improve over the shortcomings in the industry, the present disclosure is directed to methods and systems for the optimization of hydrogen fuel production, which uses a multi-stage integrated tool that allows for the design, deployment, and management of efficient microgrid hydrogen-generating plants, and/or clusters of plants, for aviation. This system may include a three-stage convex optimization to determine a plant or plant cluster location, plant design, and a plant management solution that minimizes the cost of hydrogen production where cost may be defined by the operator, e.g., by the LCOH. Convex optimization may be used where continuous setpoint of the hydrogen facility microgrid power flow controller is derived by modelling electrolyzer operation and related equipment. Such a system may be updated in real-time or configured to run over other operator-defined time scales.

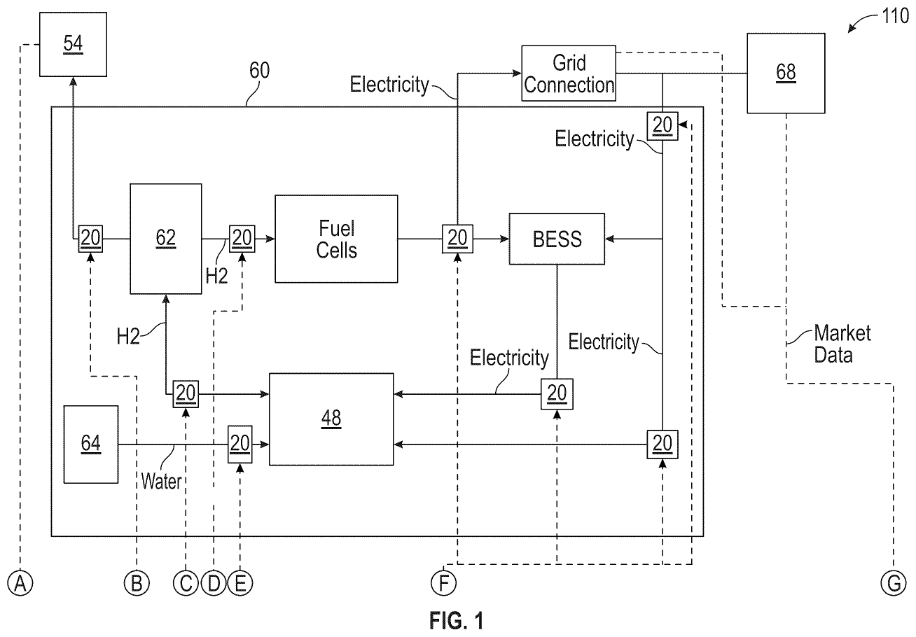

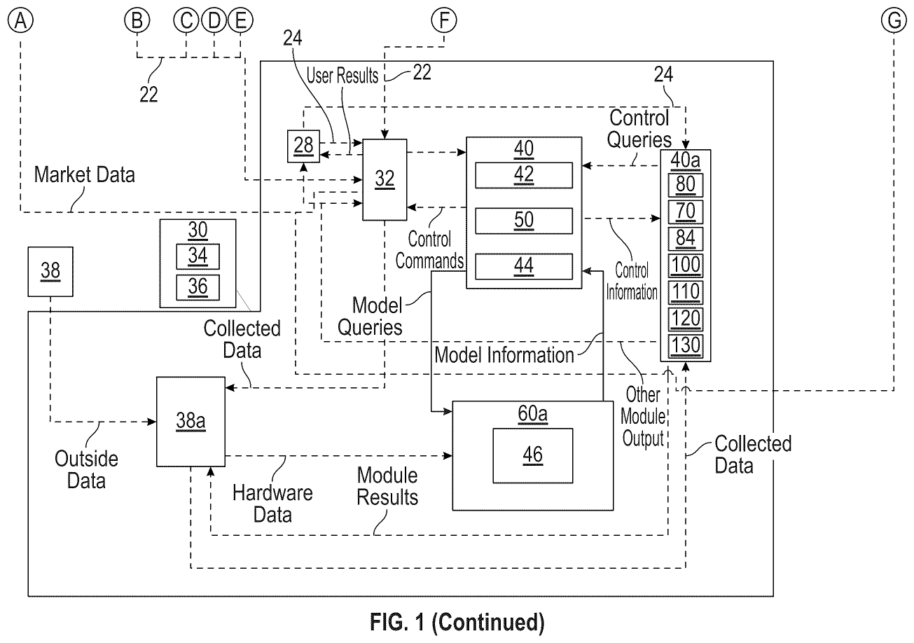

FIG. 1 is a diagrammatic illustration of a system 10 for optimizing a hydrogen fuel production facility, in accordance with the present disclosure. As shown, the H2 Plant 60 communicates data and is controlled by the modeling module 40, with additional connections to the wider electricity grid and H2 market 54.

The H2 plant 60 is now described. A fuel cell takes in H2 from the H2 storage 62 and generates electricity, which can be stored in the Battery Energy Storage System (BESS) or transported and sold via the grid connection 52 to the wider electricity grid. The BESS can additionally take in and store electricity from the grid connection 52. The BESS, the grid connection 52, or local renewable energy sources 68 can transport electricity to power the electrolyzer 48, which takes in water from a connected water supply 64 and converts it to H2 for storage in the H2 storage system 62. The H2 storage system 62 can additionally sell H2 to the connected H2 market 54. Sensor and control packages 20 are placed in each electrical connection, H2 fuel, water, or other connection between the components of the H2 plant 60 and connections leading out of the H2 plant 60, such as but not limited to the grid connection 52 and H2 market 54. These sensor and control packages 20 collect data on the flow of commodities in the connection, including the rate and quantity of the flow of the commodity, the quantity of the commodity in a component, or the quality of the commodity, and control the rate of flow along the connection. The sensor and control packages 20 are connected to modeling module 40 through the data and control I/O device 32 incorporated in the modelling module 40. For example, the sensor and control package between the H2 storage system 62 and the fuel cells measures the rate and quantity of flow of H2 and send this data to the data and control I/O device 32, while receiving commands from the device that regulate the rate of flow of hydrogen through the device.

A collection of at least one computerized device hosts the data and controls I/O device 32, the modelling modules 40, a database, and hardware models 44. The modelling module 40 is composed of the MPC controller 50, a hardware model 44, and the three-stage convex optimization model 42 working in concert. The MPC controller 50 is used to determine an optimal power flow schedule of the H2 plant 60 for a selected control scenario selection and schedule modules 120, 130. These components receive information and send control commands from a data and control I/O device 32, which receives sensor data 22 and sends control commands to and from the sensor and control packages 20 and receives market data from the H2 market 54, the grid connection 52, and local renewable energy sources 68, as necessary. A user input interface 28 is also connected to the data and control I/O device 32, which allows for users to send user input data 24 to the data and control I/O device 32 and the modelling module 40 and receive user results in return based on their inputs. Based on the market data and sensor data provided, the modelling module 40 uses its components to decide on control commands to be sent to the H2 plant 60. For example, if the market data from the grid connection 52 indicates that electricity is at a lower cost, the modelling module 40 may send control commands to the sensor and control package(s) 20 in control of the electrical connection between the grid connection 52 and the BESS to take in electricity from the grid connection 52. In another example, the modelling module 40 may consider measurements of the H2 stored in the H2 storage 62 and the price of electricity from the grid connection 52 to decide whether to send control commands for the fuel cell to take in H2 to convert to electricity to sell to the grid connection 52. In another example, the modelling module 40 may detect in an emergency situation that the flow of water to the electrolyzer 48 is too low, or the quality of water violates usable thresholds, and shut down the electrolyzer 48.

The collected data of the data and control I/O device 32, comprising of some or all of the data received by the data and control I/O device 32, is additionally transmitted to a database to be stored. Additional outside data from outside databases not part of the computerized device(s) is also collected in the database as required by the modeling module 40 and additional modules. The database provides hardware data to a plant model 60a additionally stored on a non-transitory memory 34 the computerized device 30. The computerized device 30 also includes at least one processor 36 which is capable of executing instructions to process data, and may also include any other computing components, such as, for instance, databases for storing received data. The plant hardware models 44 simulate the behavior of the H2 plant 60, including but not limited to simulations of hardware components of the H2 system 10 (e.g., a simulation of the electrolyzer 48). Hardware data provided from the database updates the initial conditions of the plant model 60a and simulated hardware components to more closely reflect the current state of the H2 plant 60, so that the plant model 60a returns predictions that more accurately reflect the future state of the H2 plant 60. The modelling module 40 may send model queries of the plant model 60a to predict the effect of a set of control commands, which the plant model 60a responds to by providing model information. For example, the MPC controller 50 will send a model query that asks for the state of the H2 plant 60 over a period of time in response to a set of control commands that may or may not happen over that period of time, which the plant model 60a will respond with by providing the state of the H2 plant 60 over each timestep in that period. This H2 plant 60 state can be used by the MPC controller 50 to estimate the predicted value of the set of control commands, including but not limited to factors such as monetary revenue generated by selling electricity or H2 generated to the grid connection 52 or H2 market 54, and the predicted value of stored electricity in the future.

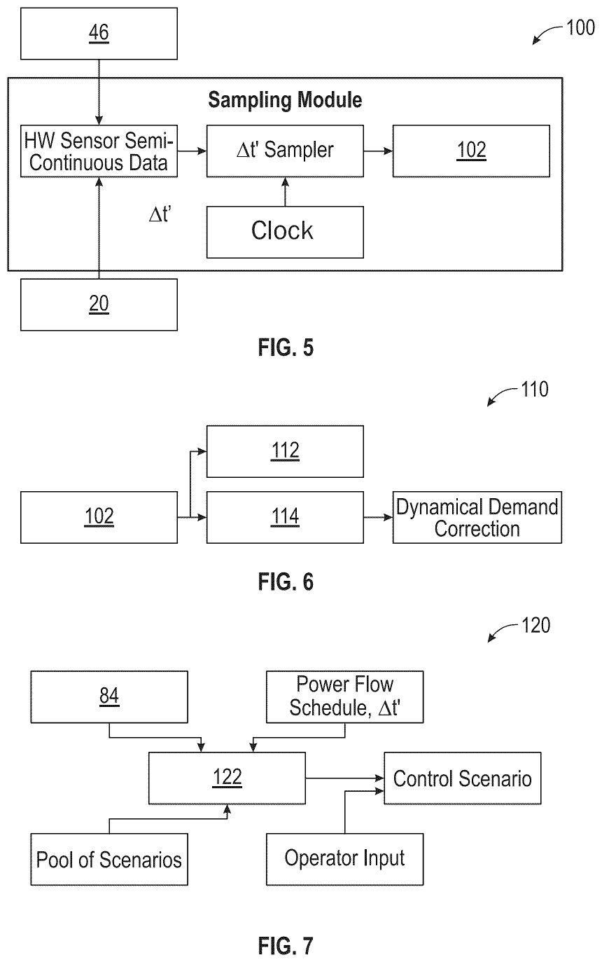

Other modules 40a, some of which are described below in relation to FIG. 5-8, are also stored on the computerized device 30. They can utilize components of the modeling module 40 for their purposes, by sending control queries to components such as the MPC controller 50, and receiving control information in response. User input data 24 from the data and control I/O device 32 send user inputs to the other modules and receives user results. The other modules may also pull collected data from an outside database 38 as described below, and store module results in the database 38a. For example, the scenario module described below stores simulated scenario information and module results in the database 38a and calls up stored scenario information in response to user inputs.

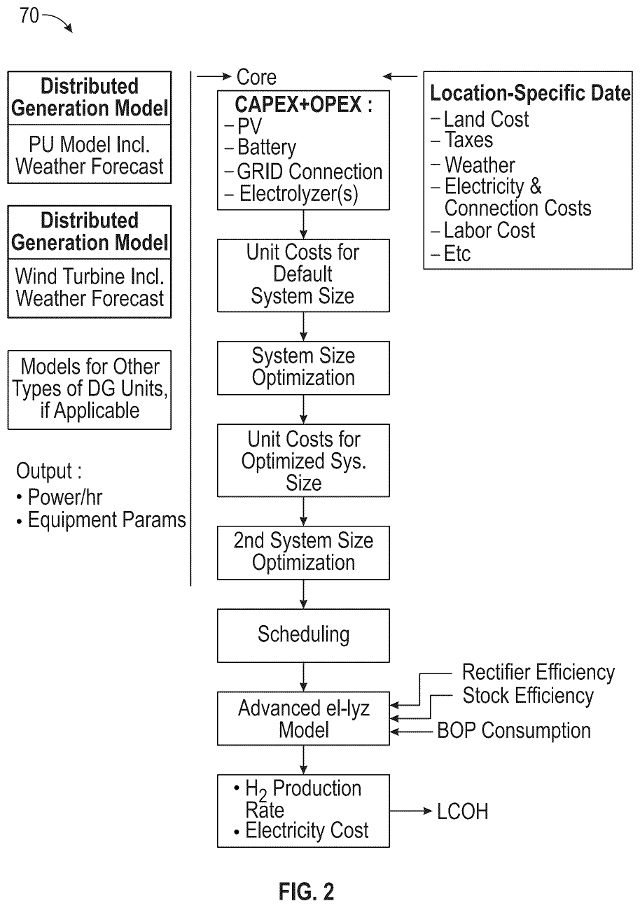

One of the benefits that system 10 provides is the ability to optimize the H2 plant 60 models and H2 plant 60 design based on techno-economic considerations. To this end, FIG. 2 is a techno-economic workflow diagram 70 of the system of FIG. 1, embedded as a module in FIG. 1. As shown, the workflow diagram 70 includes a financial modeling and design model, which provides various data and analysis over a specified time scale. For instance, this data may include optimal plant design specs for minimal LCOH, minimal LCOH value, plant performance analysis, including physical outputs over time, capacity factors, equipment performance predictions etc., and detailed financial analysis. The financial modeling and design model may account for various economic factors, including, for instance, internal rate of return, weighted cost of capital, project timeline, and inflation rate. It may also account for various engineering factors, such as a microgrid and electrolyzer model. The model may utilize various system specifications and environmental variables such as weather and geographical data, electricity market, or utility rates. The model 70 also includes hardware models based on physical equipment data, such as plant 60 components 46 and their physical parameters. The hardware model 44 may simulate the hardware component or other equipment performance over a lifetime to predict performance of the component and/or the plant 60 overall.

In use, the model 70 can divide a region of interest for a proposed plant 60 construction into smaller land areas and calculate LCOH and other parameters using the proposed techno-economic model and the hardware model 44. An optimal location of the plant 60 or a plurality of plants 60 may then be modeled using convex optimization given the specifics of the geographic site, per the models in the modeling module 40.

Modeling optimization of the plant 60 may include subsystem analysis which considers hardware and economic parameters of the subsystem of the plant 60. For instance, the model may consider the internal states and features of the plant 60, such as hardware components 46 in terms of microgrid and grid parameters. These may include, for instance, power and efficiency of hardware components 46, such that desired system, module or optimal outputs can be analyzed relative to hardware component 46 capabilities. Analysis of economic parameters may include mathematical optimization based on various parameters. These parameters may include a set of actions, such as a set of bets to buy/sell a certain amount of energy at a certain price. They may also include environmental considerations, such as a location and time specific price to buy and sell energy to the grid (locational marginal price that results from the market equilibrium). Feedback and historical data are considered too, such as to account for how much energy was bought and sold, what price was energy bought and sold (location marginal price), and the carbon intensity of the energy bought and sold.

The system 10 may provide an optimal discrete schedule for a given system configuration, which is later used as a subroutine to find the optimal configuration. These subroutines may be understood as modules embedded as other modules 40a in FIG. 1, which model the information flow for the system 10 and are described relative to FIGS. 2-9. It is noted that the models operate on various considerations. For example, the models are based on the environment being stochastic, e.g., where weather and grid patterns are day specific. As such, the system 10 may employe a Monte-Carlo approach to simulate the environment and provide an environment forecasting module, as described relative to FIG. 5. Additionally, the models may rely on a time scale approximation. Table 1 depicts a key for time scale approximation values relative to symbols used relative to FIGS. 2-9.

TABLE 1
Time Scale Approximation key

| Symbol | Time Scale Approximation | |
|---|---|---|
| Δt** | 1 day to 1 month | |
| Δt* | 1 hour to 1 day | |
| Δt | 5 | minutes |
| Δt′ | 10 | seconds |

| | |
|---|---|
| Δt″ | Less than 1 second |

Relative to the inputs and outputs of the system 10, as previously noted, both engineering, e.g., hardware-component-based data, and economic information are used as inputs. These include various types of data inputs, such as hardware sensor data, market independent system operator (ISO) data and demand/supply volumes with a power source breakdown. They may also include meteorological data, forecasted environment, emissions, footprint, or hydrogen demand, given as an order table, i.e., an amount of hydrogen needed by a given time. It is noted that emissions are considered as a measure of the continuous release of gases and other sources of negative impact to the environment, whereas footprint is characterized as a measure of the negative environmental impact during the production, installation and operation of equipment over its life cycle. Additional inputs may also be included. These inputs then are processed to the Δt′ time series. MPC controller 50 may determine an optimal power flow schedule for a selected control scenario and schedule module, which optimizes the input parameters over a time series window. The time series window may include various time windows, such as in real-time, or an operator-defined time scale, such as, for instance, five minutes.

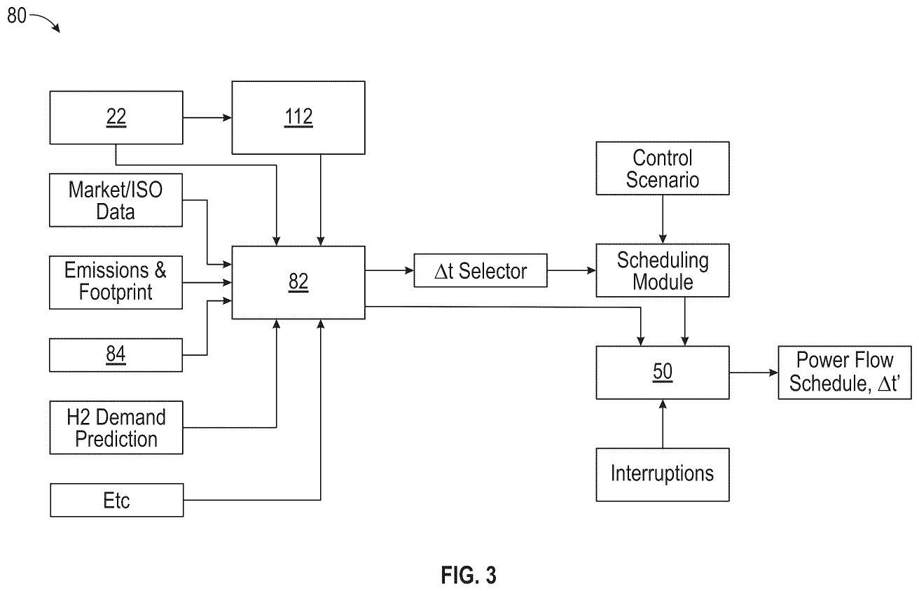

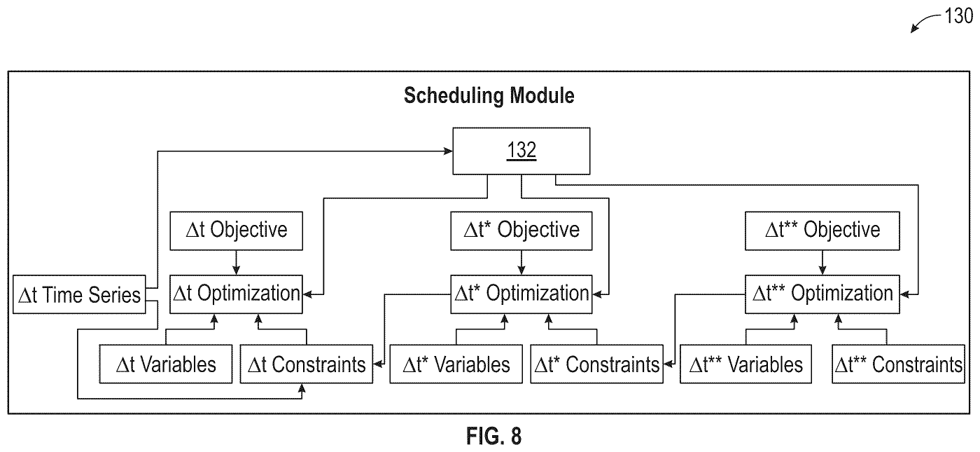

FIG. 3 is a diagrammatic illustration of a time series table generator module 80 of the system of FIG. 1. As shown, time series table generator module 80 includes a time series table generator 82 which receives data inputs. These inputs may include hardware components sensor data 22 from sensors and control package 20 (FIG. 1), data from an environmental forecasting module 112 (discussed relative to FIG. 8), Market/ISO data, emissions and footprint data, data from an H2 order table 84, H2 demand prediction data, or other data sources. The time series table generator 82 outputs time series data based on engineering and economic input from these various input sources. The time series data is fed into the MPC controller 50 which outputs the Δt′ power flow schedule. The MPC controller 50 may also receive inputs from the scheduling module, which itself receives time selection data from a Δt time selector and control scenario data. The MPC controller 50 may also receive data relative to stimulated hardware component 46 (FIG. 1) interruptions or similar hardware-related information.

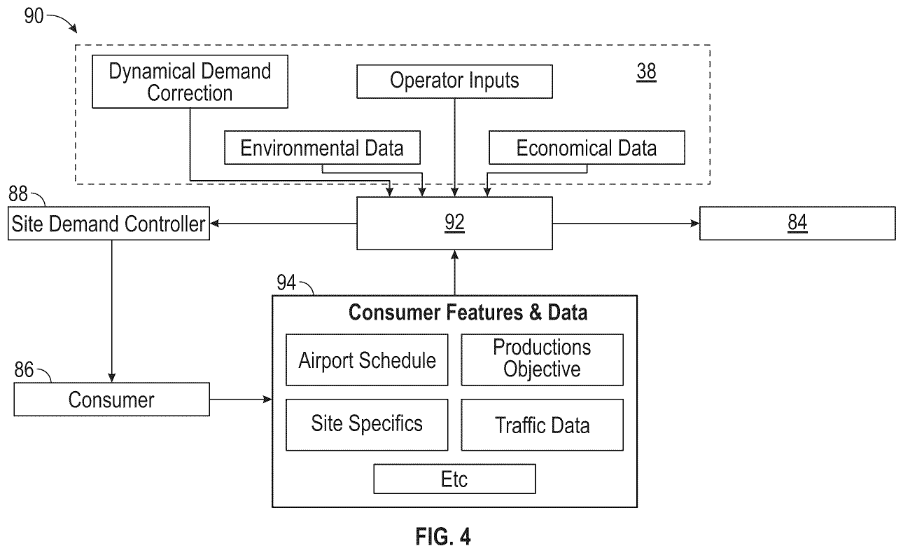

FIG. 4 is a workflow diagram of an information flow process module 90 to generate the table of hydrogen orders of the system 10 of FIG. 1. The calculation of H2 orders, e.g., the hydrogen needed by a hydrogen demand source by a specified time, may be based on demand analysis from specific location and environment data sources. For instance, an H2 demand analysis and prediction unit 92 may receive data from the outside database 38 related to dynamical demand correction, environmental data, operator or user input data 24 (FIG. 1), and economic data. The H2 demand analysis and prediction unit 92 may also receive consumer features and data 86, which may include, for instance, airport schedules, production objectives, traffic data, and site specifics, as well as others. This data is processed by the H2 demand analysis and prediction unit 92 to output an H2 order table 84 which identifies predicted H2 demand. This output may also be communicated to a site demand controller 88, such as an entity at a site that uses H2, and a consumer who uses H2, where such data can, in turn, be used to generate further consumer features and data 94.

FIG. 5 is a diagrammatic illustration of an observation database generation module 100 of the system of FIG. 1. In particular, the observation database generation module 100 may be a sampling module which is used to generate an observation database 102 from hardware component 46 data that is collected and reported as a hardware sensor semi-continuous data stream that is sensed by a Δt′ sampler at a known time period of Δt′, as reported and maintained by a clock. In this module, H2 demand may be sampled from hardware sensors and control package 20 and hardware components 46 to generate the observation database 102, which is a database of sample data. In one example, the sample may be from a flow meter where the sampling module samples hydrogen demand based on a reading from the flow meter (not shown), included in a sensor and control package. Other types of devices and other types of readings to generate samples may also be used. Sampling may occur in a continuous or a semi-continuous way to generate a database of samples, as may be desired, based on implementation of the system 10. When determining how demand prediction matches actual demand, the grid price may be piecewise.

FIG. 6 is a diagrammatic illustration of a dynamical demand correction module 110 of the system of FIG. 1. Once the observation database 102 is generated, the database may be used directly as input for the environmental forecasting module 112, which may be used to make predictions or forecasts for environmental conditions which may affect the system 10, e.g., temperature, precipitation, wind, or others. Data from the observation database 102 may also be used in an anomaly detection module 114 to detect irregularities. When anomalies are detected, the system 10 may perform dynamical demand correction for downstream H2 prediction. Dynamic demand correction may be done by detecting anomalies using the observation database 102, such as where data from the observation database 102 is compared with a database of historical demand observations.

FIG. 7 is a workflow diagram of a control scenario selection module 120 used with the system 10 of FIG. 1. The control scenario selection module 120 uses a scenario selector 122 which receives inputs relative to hydrogen demand, e.g., from the H2 order table 84, the power flow schedule, Δt′ including costs and power transfer at a given time, operator input, a pool of previous scenarios and any number of other possible sources. A control scenario for optimization may be based on any of these inputs, or any combination thereof. The scenario selector 122 may be specified by the operator, or it may be programmatic to best match the state of a plant or other facility. For example, if there is suddenly a surplus of hydrogen, then the scenario selector 122 may select a scenario that decreases priority of hydrogen production, with surplus being used for filling a battery energy storage or trading with the grid.

FIG. 8 is a workflow diagram of a scheduling module 130 used with the system 10 of FIG. 1. As shown relative to FIG. 8, the scheduling module 130 has time series optimizers to optimize over input time series variables and constraints based on objective functions defined for the various time scales. For instance, the input time series may include any time value, such as 5 minute, 1 hour to 1 day, and 1 day to 1 month, or longer (see Table 1). The scheduling module 130 may coordinate across various time scales. For instance, there may be selection of the Δt time series scales at the level of the Δt constraints or the rolling window server 132 or both, depending on implementation and use of the system. As used in this disclosure, the rolling window server 132 may be a computer system which allows for solving the problem for larger coarse-grained scales, such as relative to the system design over a period of years, using fine-grained scales, such as based on minutes, market demand-response, seconds, frequency regulation, or other small scales.

In use, the system 10 may use various levels of granularity allowing a flexible complexity accuracy trade-off. This allows it to optimize the control strategy within the prescribed time frame, e.g., from seconds to hours, with controllable output uncertainty. Model granularity in this case may refer to a spectrum of accurate vs simplified description of the system 10. For instance, one example might be a piecewise constant approximation of electrolyzer efficiency as a function of its power. Typically, the less granularity that is considered, a higher error value is likely to be received, while more granularity provides a better approximation which leads to a more accurate output. A similar approach, standing for transition from a simpler approximation to a more complex one, is used for approximating electrical and chemical losses and other non-linearities in the problem.

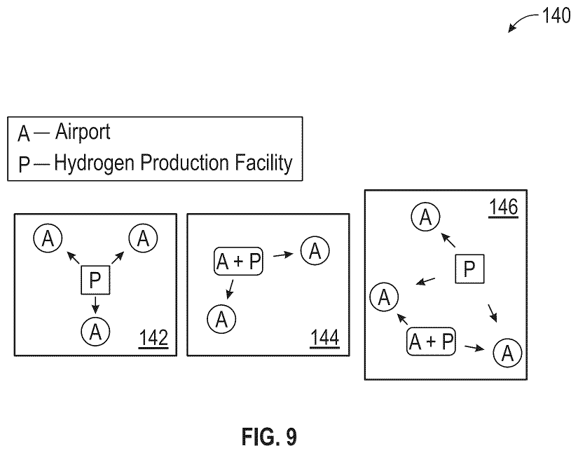

Using the system 10, it may be possible to not only design a single hydrogen plant, but also a cluster of hydrogen plants. To this end, FIG. 9 is a diagrammatic illustration of cluster topologies 140 used with the system of FIG. 1, which provides an example of a use case in designing a plant cluster topology. This particular use case is provided relative to the use of hydrogen fuel for aviation. Cluster topologies 140 may include three main types: centralized production 142, distributed production 144, and mixed production 146. In these diagrams, “A” represents an airport, and “P” represents a hydrogen production facility. As shown, a centralized production 142 may include a single production facility which is positioned in a centralized location relative to a plurality of airports. In a similar fashion, distributed production 144 also has a production facility centralized to a plurality of airports, but included within or near one of those airports. The mixed production 146 design uses a plurality of production facilities which are positioned relative to one or more airports and, in some cases, within or near an airport, such that an airport can receive hydrogen from more than one production facility.

The cluster topologies 140 may help airports design and choose between different hydrogen fuel production scenarios. The choice of cluster topology may consider the size of demand of each airport. This may also involve finding the optimal position of the hydrogen production facilities, considering various costs for land, labor, incentives, local taxes, energy and connection costs, ability to install distributed generation systems and factors affecting them, such as insulation for solar stations, wind data for wind turbines, or others.

Using the system 10, it may be possible to quickly and accurately design, deploy, and control a single plant or plant cluster that generates hydrogen at the lowest possible levelized cost based on specifics of the site or set of sites. This ability to efficiently achieve accurate and optimal design of a hydrogen plant can lead to reductions in operational costs. It also promotes efficiency and may yield longer lifetimes for hydrogen production facilities. An integrated design platform also reduces design iteration time, provides a quantitative analysis of the plant design configuration space, and can be used to derive detailed financial analysis for the plant's lifetime.

While the system 10 may offer numerous benefits to the hydrogen fuel industry, it is particularly beneficial in being able to be vertically integrated in existing plant design. All necessary steps for constructing and operating a hydrogen plant, from initial design to day-to-day management, can be accounted for by the system 10. Additionally, the system 10 can provide simulation-driven design with simulations of real hardware components, allowing the operator to accurately predict plant performance over its lifetime. Additionally, while the system 10 is particularly applicable to plant design and management for hydrogen fuel production used in aviation, the system 10 may also be advantageously used in other settings. For instance, use within any vehicle which operates on hydrogen fuel is envisioned. Additionally, the system 10 may be used in hydrogen-fuel-powered fleet vehicles with fleet management, e.g., taxis, truck fleets (delivery, trash pickup), buses, or others. In these situations, hydrogen demand may be predicted based on historical usage, weather, time of year, type of vehicle, or other factors.

It is noted that the system 10 may be extended to handle observation uncertainty (adversarial and stochastic) along with system partial observability without greatly hurting computational performance. For state estimation, the robust maximum likelihood estimation principle may allow for fitting hidden parameters of the model based on partial and uncertain data. Additionally, the convex optimization may be reformulated to minimize an operator-defined cost besides LCOH. For example, it may be possible to optimize for hydrogen plant longevity subject to a cost threshold rather than lowest cost, or based on other factors.

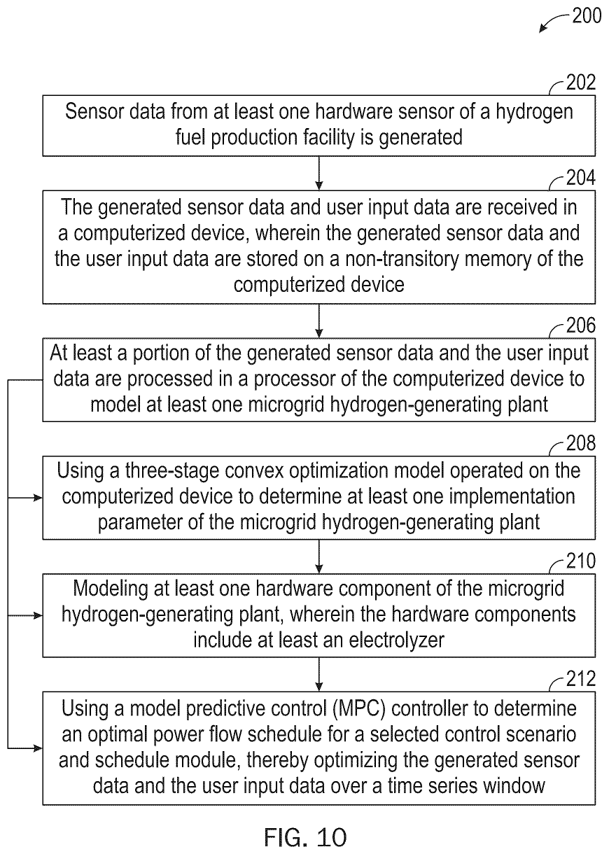

FIG. 10 is a flowchart 200 illustrating a method for optimizing a hydrogen fuel production facility, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As shown by block 202, sensor data from at least one hardware sensor of a hydrogen fuel production facility is generated. The generated sensor data and user input data are received in a computerized device, wherein the generated sensor data and the user input data are stored on a non-transitory memory of the computerized device (block 204). At least a portion of the generated sensor data and the user input data are processed in a processor of the computerized device to model at least one microgrid hydrogen-generating plant (block 206). This modeling includes: using a three-stage convex optimization model operated on the computerized device to determine at least one implementation parameter of the microgrid hydrogen-generating plant (block 208); modeling at least one hardware component of the microgrid hydrogen-generating plant, wherein the hardware components include at least an electrolyzer (block 210); and using a MPC controller to determine an optimal power flow schedule for a selected control scenario and schedule module, thereby optimizing the generated sensor data and the user input data over a time series window (block 212). It is noted that modeling may be processed concurrently based on other models or independent of other models. Any number of additional steps, functions, processes, or variants thereof may be included in the method, including any disclosed relative to any other figure of this disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

What is claimed is:

1. A method for optimizing a hydrogen fuel production facility, the method comprising:
generating sensor data from at least one hardware sensor of a hydrogen fuel production facility;
receiving, in a computerized device, the generated sensor data and user input data, wherein the generated sensor data and the user input data are stored on a non-transitory memory of the computerized device;
processing, with at least one processor of the computerized device, at least a portion of the generated sensor data and the user input data to model at least one microgrid hydrogen-generating plant by:
using a three-stage convex optimization model operated on the computerized device to determine at least one implementation parameter of the microgrid hydrogen-generating plant;
modeling at least one hardware component of the microgrid hydrogen-generating plant, wherein the at least one hardware component include at least an electrolyzer; and
using a model predictive control (MPC) controller to determine an optimal power flow schedule for a selected control scenario and schedule module, thereby optimizing the generated sensor data and the user input data over a time series window.

2. The method of claim 1, wherein the time series window further comprises at least one of: a real-time or operator-defined time scale.

3. The method of claim 1, wherein modeling the hardware component of the microgrid hydrogen-generating plant further comprises simulating the hardware component to predict performance of the microgrid hydrogen-generating plant.

4. The method of claim 3, wherein the hardware component of the microgrid hydrogen-generating plant further comprises a flow meter, wherein modeling the at least one hardware component further comprises using a sampling module to sample hydrogen demand based at least on a reading from the flow meter.

5. The method of claim 1, wherein the at least one implementation parameter of the microgrid hydrogen-generating plant further comprises at least one of aviation hydrogen fuel demand, hydrogen-fuel-powered aircraft parameters, airport parameters, or hydrogen fuel storage infrastructure parameters.

6. The method of claim 1, wherein modeling the at least one hardware component of the microgrid hydrogen-generating plant further comprises modeling at least one of an electric energy generation subsystem, a battery energy storage system, or a hydrogen fuel cell.

7. The method of claim 1, wherein using the MPC controller further comprises analyzing a techno-economic condition and a plant energy management system with at least one artificial intelligence (AI) data model.

8. The method of claim 7, wherein analyzing the plant energy management system further comprises analysis of actions, environmental parameters, feedback parameters, and internal states of the microgrid hydrogen-generating plant.

9. The method of claim 1, wherein modeling the microgrid hydrogen-generating plant further comprises detecting anomalies using an observation database.

10. The method of claim 1, wherein modeling the hardware component of the microgrid hydrogen-generating plant further comprises generating a constant approximation of electrolyzer efficiency as a function of power.

11. A system for optimizing a hydrogen fuel production facility comprising:
at least one hardware sensor of a hydrogen fuel production facility generating sensor data;
a computerized device receiving the generated sensor data and user input data, wherein the generated sensor data and the user input data are stored on a non-transitory memory of the computerized device;
at least one processor of the computerized device, wherein at least a portion of the generated sensor data and the user input data are used to model at least one microgrid hydrogen-generating plant by:
using a three-stage convex optimization model operated on the computerized device to determine at least one implementation parameter of the microgrid hydrogen-generating plant;
modeling at least one hardware component of the microgrid hydrogen-generating plant, wherein the hardware components include at least an electrolyzer; and
using a model predictive control (MPC) controller to determine an optimal power flow schedule for a selected control scenario and schedule module, thereby optimizing the generated sensor data and the user input data over a time series window.

12. The system of claim 11, wherein the time series window further comprises at least one of: a real-time or an operator-defined time scale.

13. The system of claim 11, wherein modeling the hardware component of the microgrid hydrogen-generating plant further comprises simulating the hardware component to predict performance of the microgrid hydrogen-generating plant.

14. The system of claim 13, wherein the hardware component of the microgrid hydrogen-generating plant further comprises a flow meter, wherein modeling the at least one hardware component further comprises using a sampling module to sample hydrogen demand based at least on a reading from the flow meter.

15. The system of claim 11, wherein the at least one implementation parameter of the microgrid hydrogen-generating plant further comprises at least one of aviation hydrogen fuel demand, hydrogen-fuel-powered aircraft parameters, airport parameters, or hydrogen fuel storage infrastructure parameters.

16. The system of claim 11, wherein modeling the at least one hardware component of the microgrid hydrogen-generating plant further comprises modeling at least one of an electric energy generation subsystem, a battery energy storage system, or a hydrogen fuel cell.

17. The system of claim 11, wherein using the MPC controller further comprises analyzing a techno-economic condition and a plant energy management system with at least one artificial intelligence (AI) data model.

18. The system of claim 17, wherein analyzing the plant energy management system further comprises analysis of actions, environmental parameters, feedback parameters, and internal states of the microgrid hydrogen-generating plant.

19. The system of claim 11, wherein modeling the microgrid hydrogen-generating plant further comprises detecting anomalies using an observation database.

20. The system of claim 11, wherein modeling the hardware component of the microgrid hydrogen-generating plant further comprises generating a constant approximation of electrolyzer efficiency as a function of power.
